(19) United States
(12) Patent Application Publication
(10) Pub. No.: US 2009/0126098 A1
(43) Pub. Date: May 21, 2009

(54) Infrared Sauna with Metal Board Coating

(76) Inventor: Gary Gong, Shenzhen (CN)

Correspondence Address: JOHN CHEN, ROOM 303, 3F, NO. 25, SEC. 1, CHANGAN E. ROAD, TAIPEI, 10441, TW

(21) Appl. No.: 11/941,982

(22) Filed: Nov. 19, 2007

(51) Int. Cl. A61H 33/06; F26B 3/30

(52) U.S. Cl. 4/524; 392/407

(57) ABSTRACT

An infrared sauna is provided. The infrared sauna comprises a chamber formed of a floor, a plurality of side walls a door and a ceiling, a far infrared-heater embedded in the chamber and a control and display device mounted in the chamber. The side wall and door are three-ply conformation of a wood board, an outer protecting layer and a heat preservation material layer therebetween. The sauna has a metal board as a outer protecting layer, it keeps old classic style inner chamber and brings consumer much more wider choice margin of sauna house modeling. The arrangement of the infrared reflecting glass helps promote infrared radiation absorption by the user.

### BACKGROUND OF THE PRESENT INVENTION

1. Field of Invention

The present invention relates to a sauna, and more particularly to an infrared sauna with metal board coating.

2. Description of Related Arts

The use of infrared heater in a sauna room is well known, for human body deeply absorbs infrared radiation to promote the formation of perspiration and make muscle strong.

CN2591132Y discloses a portable infrared sauna comprising a chamber made of wood, which is more and more rare resource in the world. And the chamber is complex in structure and not easy to carry for its high weight.

CN2778972Y discloses an infrared sauna made including a chamber. The chamber comprises a frame made of alloy, polymer boards mounted to the frame and heat preservation material embedded between two polymer boards. This type of sauna loses the old classic style, for no wood is used. The polymer tends to age and makes the sauna cannot last a long time.

### SUMMARY OF THE PRESENT INVENTION

A main object of the present invention is to provide an infrared sauna, the rare wooden material is replaced by metal board as a outer protecting layer, inner chamber it still keeps the wooden classic style, which brings consumer much more wider choice margin of sauna house modeling, it is also easy to disassemble and clean and costs a little wood.

Accordingly, in order to accomplish the above object, the present invention provides an infrared sauna comprising:

a chamber formed by a floor, a plurality of side walls, a door and a ceiling, wherein the side wall and door are three-ply conformation of a wood board, an outer protecting layer and a heat preservation material layer therebetween;

a far infrared-heater embedded in said chamber, and

a control and display device mounted in said chamber.

In a preferred embodiment, the outer protecting layer is a metal board.

In a more preferred embodiment, the side wall and door further include a support frame made of wood rod, the metal board is mounted to the support frame.

In a most preferred embodiment, the metal board is embedded in or threadedly connected to the support frame.

In a more preferred embodiment, an infrared reflecting glass board is embedded in the wall or door which is opposite to said far infrared-heater.

In a most preferred embodiment, the metal board has a coating layer.

An advantage of the present invention is that it keeps the wooden classic style and cots a little wood, for its unique structure of a wooden inner wall and a metal board coating as a outer protecting layer. Another advantage of the present invention is that the infrared reflecting glass helps promote infrared radiation absorption by the user.

These and other objectives, features, and advantages of the present invention will become apparent from the following detailed description, the accompanying drawings, and the appended claims.

### BRIEF DESCRIPTION OF THE DRAWINGS

FIG. 1 is an assembly drawing of an infrared sauna according to a first preferred embodiment of the present invention.

FIG. 2 is a front view of a door of an infrared sauna according to a first preferred embodiment of the present invention.

FIG. 3 is an amplified A-A cross section of the door of an infrared sauna according to a first preferred embodiment of the present invention.

FIG. 4 is an amplified B-B cross section of the door of an infrared sauna according to a First preferred embodiment of the present invention.

FIG. 5 is an amplified C section of B-B cross section of the door of an infrared sauna according to a first preferred embodiment of the present invention.

### DETAILED DESCRIPTION OF THE PREFERRED EMBODIMENT

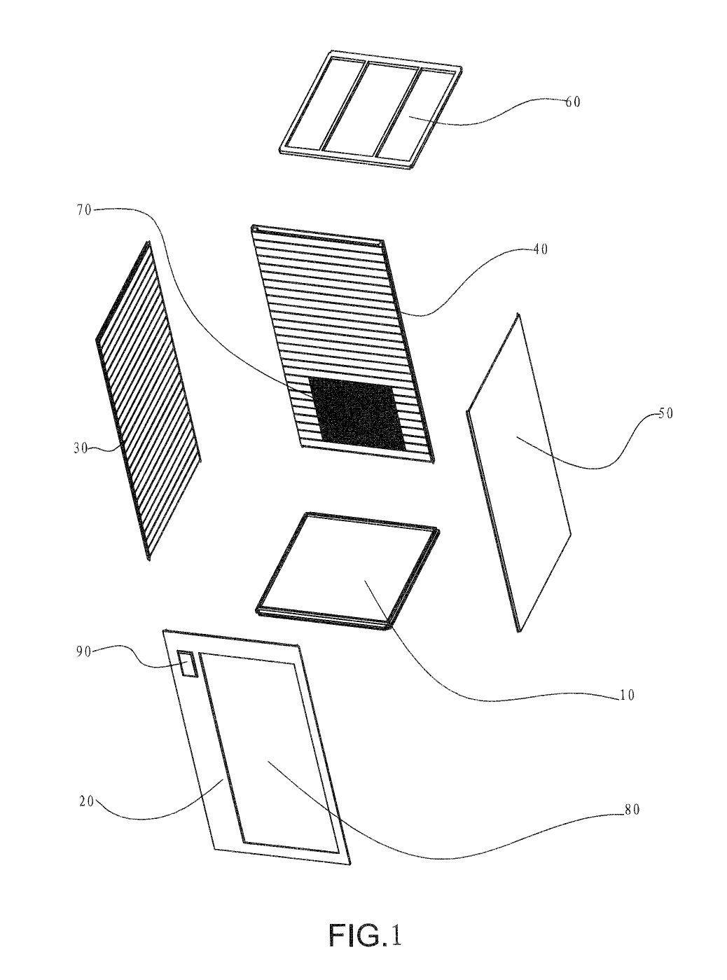

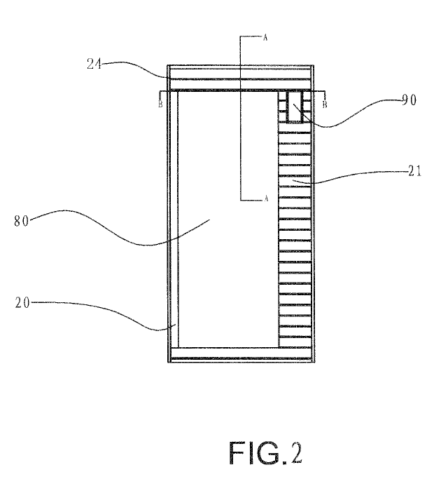

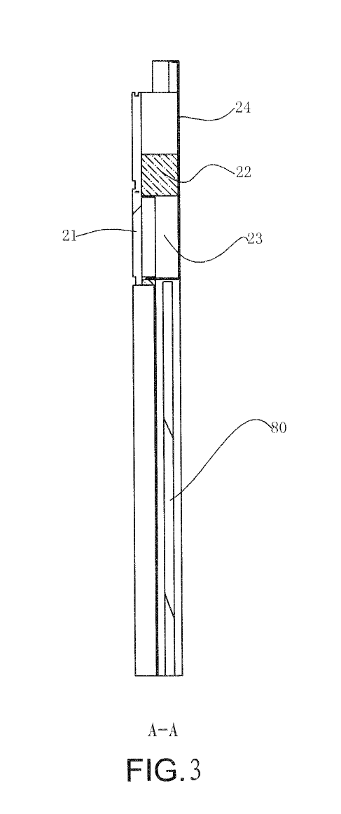

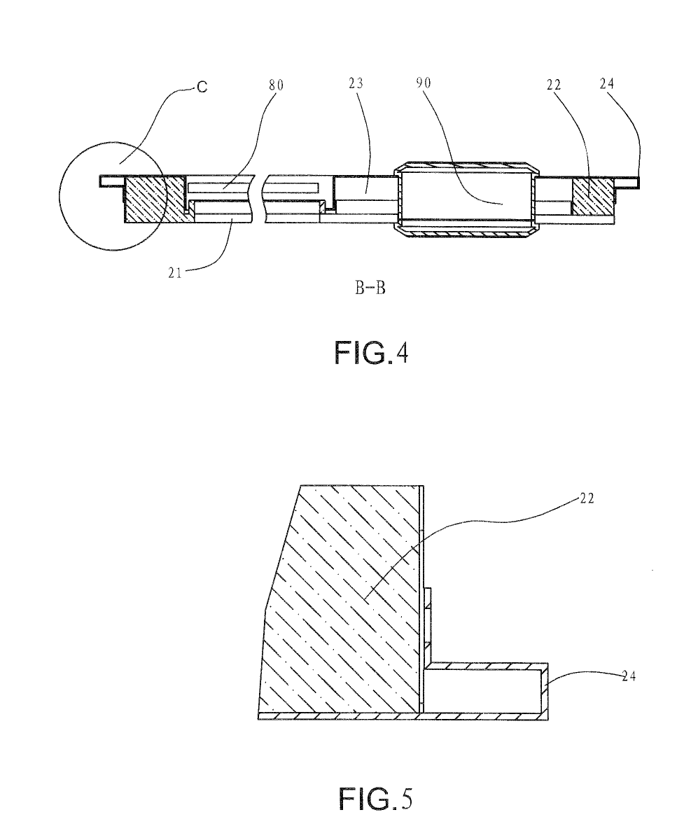

Referring to FIG. 1 to FIG. 5, an infrared sauna according to a first preferred embodiment of the present invention is illustrated, in which the infrared sauna comprises a chamber formed of a floor 10, a door 20, a left side wall 30, a rear side wall 40, a right side wall 50 and a ceiling 60, a far infrared-heater 70, an infrared reflecting glass board 80 and a control and display device 90. Not showing in the drawings, the left side wall 30, the rear side wall 40 and the right side wall 50 are connected from each other by bolts. The floor 10 and the ceiling 60 are blocked among the left side wall 30, the rear side wall 40 and the right side wall 50. The far infrared-heater 70 is imbedded in the rear side wall 40 and closes to the floor 10. The door 20 is hingedly mounted at the left side wall 30 or the right side wall 50. The infrared reflecting glass board 80 is imbedded in the door 20 to reflect the far infrared ray transmitting by the user in the sauna. The control and display device 90 is mounted to the door 20, for controlling the infrared-heater 70 and displaying controlling data.

The door 20 is three-ply conformation and includes a wood board 21, a support frame formed of wood rod 22, a heat preservation material layer 23 and an iron board 24. The wood board 21 and the iron board 24 are imbedded in or threadedly connected to the support frame on its opposite side. The heat preservation material layer 23 is Filled in the interspace between the wood board 21 and the iron board.

The left side wall 30, the rear side wall 40 and the right side wall 50 are the same in structure as the door 20. There is no more description to make the specification pithy. The floor 10 and ceiling 60 are made of wood.

It will thus be seen that the objects of the present invention have been fully and effectively accomplished. It's embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. An infrared sauna, comprising:
a chamber formed of a floor, a plurality of side walls, a door and a ceiling, wherein said side wall and door are three-ply conformation of a wood board, an outer protecting layer and a heat presentation material layer therebetween;
a far infrared-heater embedded in said chamber; and
a control and display device mounted in said chamber.

2. The infrared sauna, as recited in claim 1, wherein said outer protecting layer is a metal board.

3. The infrared sauna, as recited in claim 2, wherein said side wall and door further include a support frame made of wood rod, said is metal board mounted to said support frame.

4. The infrared sauna, as recited in claim 3, wherein said metal board is embedded in or threadedly connected to said support frame.

5. The infrared sauna, as recited in claim 1, wherein an infrared reflecting glass board is embedded in the wall or door locating oppositely to said far infrared-heater.

6. The infrared sauna, as recited in claim 2, wherein said metal board has a coating layer.
